(19) United States
(12) Patent Application Publication
(10) Pub. No.: US 2023/0063889 A1
(43) Pub. Date: Mar. 2, 2023

(54) METHOD FOR MANUFACTURING SECONDARY BATTERY, OR SECONDARY BATTERY

(71) Applicant: MTEK-SMART CORPORATION, Yokohama-Shi, Kanagawa (JP)

(72) Inventor: Masafumi MATSUNAGA, Yokohama-Shi (JP)

(73) Assignee: MTEK-SMART CORPORATION, Yokohama-Shi, Kanagawa (JP)

(21) Appl. No.: 17/794,733

(22) PCT Filed: Jan. 20, 2021
(86) PCT No.: PCT/JP2021/001907

§ 371 Date: Jul. 22, 2022

(30) Foreign Application Priority Data
Jan. 23, 2020 (JP) 2020-009484

(51) Int. Cl. H01M 4/04; H01M 4/38; H01M 4/583; H01M 10/0525; H01M 10/0565

(52) U.S. Cl. CPC H01M 4/0404; H01M 4/386; H01M 4/583; H01M 10/0525; H01M 10/0565; H01M 2004/027

(57) ABSTRACT

A method for manufacturing secondary batteries, forming a positive electrode for lithium-ion batteries, it was necessary to select polyvinylidene fluoride (PVDF) or the like as a binder due to the problems of heat resistance or chemical resistance when using a liquid electrolyte such as an organic solvent. Solvents which can dissolve such a resin are limited to normal methylpyrrolidone (NMP) and the like, have a high boiling point, and require a long, high-temperature oven.

By mixing a slurry with a low boiling point solvent, and applying the resultant mixture to a heated object, a parent solvent evaporates due to the azeotropic effect of the low boiling point solvent, and spraying, especially pulsed spraying can evaporate at least 90% of the parent solvent on the object within 5 seconds even when the temperature of the object is 100° C. lower, preferably at least 50° C. lower than that of the parent solvent. Therefore, a drying device has a very small total length, thus by lamination in the form of a thin film, the positive electrode can be easily made into a thick film thickness.

### TECHNICAL FIELD

The present invention relates to a method for manufacturing a secondary battery, and in detail, particles or short fibers or the like of an active material or a conductive assistant, etc. are mixed with a binder solution to form a slurry, an electrode layer is formed on current collectors of both electrodes, a separator is used as an intermediate layer, and an electrolyte liquid is sealed to manufacture, for example, a lithium ion secondary battery. In addition, in an all-solid-state battery, an intermediate layer is usually not required except for the case where, instead of the separator, a heat-resistant film such as polyimide is provided with many openings, and the openings are filled with solid electrolyte particles or electrolyte short fibers to be used as an electrolyte. Since the intermediate layer is used in the above-mentioned method, in the present invention, an intermediate member having an opening is treated as as a separator, and the one for which the opening is filled with a solid electrolyte material mainly containing a polymer ion material that is solid at room temperature is treated as an electrolyte layer. It also includes a method for manufacturing an all-solid-state battery composed of a laminate in which an electrolyte layer is formed of solid electrolyte particles or the like, and a positive electrode layer, an electrolyte layer, and a negative electrode layer are laminated, and a next-generation secondary battery such as the manufactured all-solid-state battery. Although the method for manufacturing an all-solid-state battery is mainly described in the detailed description, the present manufacturing method is suitable for all storage batteries including lithium ion secondary batteries and can also be applied to all-solid-state air batteries or the like, which are considered to be promising next-generation batteries.

The present invention is a method for manufacturing a secondary battery or a secondary battery, and more particularly, at least one of a current collector for positive electrode, a positive electrode layer, an electrolyte layer, a negative electrode layer, a current collector for negative electrode, a separator for electrolyte is used as an object, a desired material is selected from various materials such as positive electrode active material particles, electrolyte particles or short fibers, negative electrode active material particles or short fibers, conductive assistant particles or short fibers, binders or, if necessary, electrolyte polymers, a solvent is added and mixed to form a slurry, or each type of particles or fibers may be independently made into a slurry or the like, or all the particles or the like are mixed to form a slurry, which is applied or laminated and applied to the object to manufacture a secondary battery or an all-solid-state battery. Particles or fibers may be directly applied to the object without forming a slurry. Alternatively, the materials may be formed into a film on the object as they are particles or fibers by an aerosol deposition (AD) method or the like, but since the material and the diameter size or the like of the particles are limited, the option is expanded when a slurry is formed and applied.

The application according to the present invention is not particularly limited, it includes roll coating, slot nozzle (slot die) coating, slit nozzle coating in which a slurry or the like is made into particles and ejected from an elongated slit groove, screen printing, curtain coating, dispenser application, inkjet, spraying, atomization (fibrousization) application including spraying and rotary atomization in which a bell or a disc rotates at high speed to atomize by centrifugal force, a method for applying particles or fibers directly or indirectly to an object by using suction or the like, such as electrostatic atomization (fiberization), and also includes micro curtain application.

A micro curtain is a method for applying by using a liquid film part before becoming mist and relatively moving the object to be coated and the spraying nozzle when spraying liquid or the like at a relatively low pressure of around 0.3 MPa by an airless spraying nozzle with a wide-angle pattern or the like, for which overspraying particles are not generated on the coated surfaced. It is a method that utilizes the characteristic of changing into a mist when the distance is increased after passing through the object to be coated.

In addition, an atomization (fiberization) application is a method for applying by, in addition to atomizing by spraying, by atomizing liquid or the like containing solid fine particles while dispersing it by ultrasonic waves or the like, or by atomizing or fiberizing by spin such as electrospinning and centrifugal force by a rotating body. In addition, fine particles that are atomized by spraying or other methods such as bubbling and ultrasonic waves or the like or generated by colliding with other objects or the like, can be carried by carrier gas and applied as they are. Particles or the like can be charged and applied. Alternatively, a method for extending and jetting a group of particles at high speed with another compressed gas and applying them in an ultrafine pattern, and a method for producing particles or fibers corresponding to an object with wide and high-speed line speed by applying a melt blown method or the like to liquid are also included. Since direction of the atomized particles is unstable in the ultrasonic atomization and centrifugal atomization, it refers to a method for adhering or applying them to an object by the force of a compressed gas such as argon and nitrogen that are inert gases, if necessary, dry compressed air. In the present invention, these are collectively described as sprayings below.

### BACKGROUND ART

With the increase in mobiles and electric vehicles, high power and quick charging of secondary batteries including lithium batteries are required, but large electric vehicles or the like require one hour or more. The development to change the electrolyte from liquid to solid is progressing due to the length of the time, risk of safety, miniaturization and higher performance of the battery system. In this case, the purpose is to reduce the total space for reasons such as not requiring a cooling device, and to shorten the time for 80% charging to several minutes.

In Patent Literature 1, a method for manufacturing a layer structure of a solid electrolyte layer, a positive electrode active material layer, and a negative electrode active material layer of an all-solid-state battery is proposed, and a technique for which a slurry containing materials constituting the layer structure is prepared to form a green sheet, and the green sheet and a sheet having unevennesses that disappear by heating are integrally formed, and unevennesses are formed on the surface of the green sheet, the integrally formed green sheet and the sheet are heated to eliminate the sheet member, and an electrode is formed while forming unevennesses on the substrate by calcinating a green sheet or the like.

In Patent Literature 2, a polyvinyl acetal resin that can be degreased at low temperature in a short time has been proposed, which is used for an electrode slurry composed of active material particles, a solvent and a binder, and is used for an electrolyte slurry composed of electrolyte particles, a solvent and a binder, and these slurries are used for forming an electrode layer and an electrolyte layer of an all-solid-state battery and laminating them. More specifically, a solid electrolyte slurry, a negative electrode slurry or a positive electrode slurry is applied to support layer of the PET film that has been demolded, dried at 80° C. for 30 minutes, then the PET film is peeled off, and the electrolyte layer is sandwiched between the negative electrode and positive electrode active material layers and heated and pressed at 80° C. and 10 KN to obtain a laminate, and a conductive paste containing acrylic resin is coated on a stainless steel plate to prepare a current collector, and the binder is degreased by calcinating at 400° C. or lower in a nitrogen gas atmosphere.

In the method of Literature 1, it is ideal to apply the active material slurry or the electrolyte slurry to the sheet such as polyvinyl alcohol formed with unevennesses to increase the contact area of the active material layer or the electrolyte layer, but there is a problem that it is necessary to eliminate the resin component at a high temperature for a long time, for example, it takes 50 hours at 700° C.

On the other hand, In Literature 2, it takes 30 minutes to volatilize the solvent component of the slurry at 80° C., so there is a problem that the line becomes too long in order to replace the current line speed of, for example, 60 m/min for lithium ion batteries, or the line speed has to be slown down.

In addition, in either method, if the binder of the slurry is eliminated or reduced to a very small amount, particles will precipitate at places where the slurry tends to stay in a general circulation device, and coating cannot be performed with a die head used for forming electrodes of lithium batteries. In addition, for each electrode, it is necessary to uniformly mix the active material particles and the electrolyte particles or the conductive assistant in a desired ratio to form an electrode, but especially when the binder content is 10% or less, or even 5% or less, even if it is uniformly dispersed and mixed with a commercially available dispersion device, it will change over time, and only electrodes with unstable performance can be formed.

In addition, PVDF (polyvinylidene fluoride) is often used as a binder for a lithium ion secondary battery due to its solvent resistance and heat resistance or the like, but only high boiling point NMP (normal methylpyrrolidone) and highly toxic DM For the like can dissolve PVDF. In the case of NMP, evaporation of the solvent requires an excessively high temperature and drying time, and the existing application devices and drying devices for forming positive electrodes of secondary batteries have become huge, and when a thick film is desired, for example, when a positive electrode film thickness of 0.2 to 2 mm is desired, there are difficulties such as accruance of cracks.

### CITATION LIST

### Patent Literature

Patent Literature 1: WO2012/053359
Patent Literature 2: JP2014-212022

### SUMMARY OF INVENTION

### Technical Problem

The present invention is to improve productivity and to improve battery performance. The positive electrode active material may be a ternary system. In addition, as the porous carbon such as porous carbon having a larger surface area than usual of the negative electrode active material, a structure that encloses silicon particles or silicon oxide which are other active materials is preferable. Among the porous carbons, although the particle size is small, Ketjen Black EC600JT is well known and its BET specific surface area is 1270 m²/g. The present inventor expects mesopores or macropores with a BET specific surface area of 2000 m²/g or more, and the world-famous porous carbon with a large specific surface area is known to be developed by Professor Tokachev of the Tambov State Technical University, Russia. On the other hand, carbon nanofibers and single-walled carbon nanotubes or the like, which are often used for the purpose of improving the performance of conductive assistants, tend to agglomerate. Especially when the binder is eliminated or reduced to a very small amount, agglomeration becomes remarkable, so it is necessary to devise ways to make the specific gravity of them close to the solvent or the like, or to devise ways to select a plurality of solvents having good dispersibility. In particular, it is ideal that the conductive assistant is not made into a composite slurry of short fibers or fine particles and a binder or the like, but is simply dispersed with water or water and alcohol, for example, like a dispersion liquid of nanodiamond, and handled alone. However, since the positive electrode slurry dislikes water, in the present invention, carbon fibers or single-walled carbon tubes may be dispersed in a low boiling point liquefied carbon dioxide and the ejection port may be heated, or the spraying may be performed in a supercritical state. The supercritical fluid can be used by mixing with a slurry containing a binder and a parent solvent for binder. On the other hand, in general, if the amount of the binder is reduced, the dispersed state of the active material and the electrolyte changes over time and the performance deteriorates, so it is necessary to solve the problem.

In the present invention, the type of sulfide-based or oxide-based solid electrolyte particles is not limited. In addition, the type of active material particles for positive electrode or negative electrode is not limited.

For example, when the electrolyte is sulfide-based, for example, lithium phosphorus sulfur (LPS), the positive electrode active material may be lithium sulfide (Li₂S) particles or a mixture of sulfur, especially octasulfur (S₈) particles, and a conductive assistant, and the negative electrode active material may be particles of graphite and silicon. The negative electrode may be a metallic lithium plate or a lithium alloy plate. In addition, when the electrolyte is an oxide-based lithium lanthanum zirconia (LLZ), the positive electrode active material may be octasulfur, and a conductive assistant such as carbon nanofibers and single-walled carbon nanotubes may be used to improve conductivity, or the negative electrode may be a mixture of graphene and porous carbon. In addition, when the positive electrode active material is lithium sulfide, the lithium conductive assistant may be a mixture of lithium iodide. Lithium iodide may be made into a solution with a parent solvent, or may be made into a slurry or a suspension (emulsion) using a poor solvent or the like.

### Solution to Problem

The present invention has been made to solve the above-mentioned problems, and an object of the present invention is to manufacture high-quality secondary batteries and next-generation secondary batteries, particularly all-solid-state batteries and all-solid-state air batteries or the like, by mainly mixing the active material particles for positive electrode or negative electrode and the particles or short fibers for electrolyte with an independent device, if necessary, selecting all or some of them and mixing them until the foremost end of the application device, and further, if necessary, alternately laminating and applying the conductive assistant with other slurries for electrodes in the form of a thin film or forming a film on the current collector for positive electrode or the electrolyte layer by using an independent device. In addition, the present invention has further evolved it, and as a detailed supplement to the above, a single or multiple slurry flows or flow of low boiling point solvent other than the parent solvent for binder can be merged at the upstream of the automatic opening/closing valve of the application device, or just before the automatic opening/closing valve, or at the foremost end of the head, if necessary, at the slot nozzle part or the spraying nozzle part, to mix all the materials to form a single slurry to be applied to the object. Especially in the case of a solvent with a low boiling point, the slurry separates instantaneously, so it is necessary to incorporate a dispersion device between the slurry storage tank or the like and the application device, and for example, circulate it by using a circulation circuit to prevent the separation of the slurry at the wetted portion of the application device, including inside of the pipe. In the method of the present invention, since it can be easily atomized by rotary atomization or spraying using compressed gas, in addition, since it can be atomized and applied with a melt blown method that uses compressed gas, a general two-fluid spraying including an air assist slot nozzle, or a slit spraying nozzle that can spray a wide range from a narrow and elongated groove, or the like, the agglomerates downstream of the application device can be applied to the object while being subdivided. Further, in the present invention, for example, when a slurry for positive electrode using NMP as the parent solvent for binder and a poor solvent that has a boiling point lower than NMP and that separates in a normal device are mixed and applied, a device capable of micro-dispersion is incorporated into the material handling device, uniform slurry dispersion is desired in the material handling device, that is, from the storage tank such as a tank to the pump, pipe, and wetted circulation circuit upstream the material opening/closing valve, when the inner diameter of the pipe is ¼ inch or less and the flow velocity is, for example, 0.3 m/sec or more, preferably 1 m/sec or more, separation does not occur and particle precipitation can be eliminated. It is also possible to detach the slurry filled in through-holes or the like of a rotary screen or a sheet screen or the like with a compressed gas and apply it as particles (screen spraying). A plurality of them can be arranged in series in the moving direction of the object to enable the lamination and application. Not only a single type of slurry or the like but also multiple types can be prepared and applied repeatedly. These methods, in particular, screen spraying can be preferably applied to fields other than secondary batteries, such as CCM formation for fuel cells, etc., solar cell fields, electronics, WEB coating, and thin film lamination such as general coating of single-sheet objects such as building materials or the like. The cost of the material handling device can be reduced by making the slurry have a solid content and a viscosity at which solid particles do not easily settle in a retention place of a large drum or tank or the like for storage. Also from the viewpoint of reducing the content of high boiling point solvents such as NMP and shortening the drying time, the solid content is preferably 50% or more, more preferably 70% or more. Viscosity is 4000 mPa s or more, preferably 8000 mPa s or more. On the other hand, in order to improve the application suitability of the slot nozzle method or the spraying method or the like, the viscosity of slurry can be reduced by heating the material handling device or the application device. For example, it can be achieved by using a commercially available heater that has passed the labor inspection standard for pressure-resistant explosion-proof for the material handling device and circulating the slurry with a pump or the like. In addition, in the present invention, when the solid component has a relatively low viscosity of 2000 mPa s or less and the particles are easy to settle, or when the viscosity is high as described above, especially when the cohesive force is strong, for example, by mixing bubbles of air or inactive gas such as nitrogen and circulating the slurry in the material handling device, it is possible to improve the chixo property and prevent sedimentation, and even in the case of high viscosity, the cohesive force can be reduced by the force of bubbles, so it is suitable for spraying. On the other hand, when the object is heated, the solvent is instantaneously volatilized, and a positive electrode layer with a desired film thickness per layer and an ideal thick-film suitable for lamination can be formed. The thickness of the positive electrode layer can be selected from a wide range from micrometer units to millimeter units. Even in this case, it is preferable to use a plurality of types of solvents for azeotropic boiling, and it is desirable that one type of solvent has a boiling point of 110° C. or lower. Since the solvent emphasizes azeotropic boiling, it may be a poor solvent for binders such as PVDC, such as heptane.

In the present invention, the method of WO2013108669 invented by the present inventor, that is, a method of accurately managing the application weight per unit area by applying to an application weight measuring object for measurement before applying to the object can be used. In addition, the flow velocity of each slurry can be managed by a method that can be managed from outside the flow path such as a commercially available pipe, and the consistency with the data in the application weight measuring device can be confirmed. Therefore, the application weight of each material can be instantly managed up to fine parts of the electrode, and an ultra-high quality electrode or the like can be formed.

According to the present invention, there is provided a method for manufacturing a secondary battery, which includes an assembly of a positive electrode, a negative electrode, and an electrolyte material of the secondary battery, including:

preparing a slurry from a plurality of materials selected from positive electrode active material particles, electrolyte materials, negative electrode active material particles or short fibers, conductive assistant particles or short fibers, thickeners, binders, and parent solvents for the thickeners or the binders;

moving the slurry from an independent material handling device prepared for the slurry;

moving a solvent having a boiling point lower than that of a parent solvent for the slurry by another material handling device;

merging the slurry and the low boiling point solvent to form a merged liquid; and

applying the merged liquid to the object;

wherein the object is at least one of a current collector for positive electrode, a positive electrode layer, a separator, an electrolyte layer, a current collector for negative electrode, and a negative electrode layer.

According to the present invention, there is provided a method for manufacturing a secondary battery, wherein the low boiling point solvent is mixed with the slurry in advance to form a mixed fluid, the mixed fluid is dispersed in the material handling device to form a dispersed slurry, and the dispersed slurry is circulated at a flow velocity that does not cause separation of the low boiling point solvent and the slurry, or is moved to the application device and applied to the object by the application device.

According to the present invention, there is provided a method for manufacturing a secondary battery, wherein the object is heated at the time of application, evaporation of the parent solvent is accelerated by the evaporation of the low boiling point solvent, and the slurry is applied by the application device.

According to the present invention, there is provided a method for manufacturing a secondary battery, wherein the low boiling point solvent is a poor solvent with respect to the binder.

According to the present invention, there is provided a method for manufacturing a secondary battery, wherein the binder or the thickener for slurry can be selected from a plurality of types, a parent solvent can be selected as the solvent for binder, and particles of the slurry can be selected from a plurality of types of solid particles or short fibers, or a single or multiple independent slurries selected from a plurality of types of particles or short fibers are prepared, they are mixed with the low boiling point solvent to form a mixed fluid which is applied to the object, as method for mixing or applying them, at least one method selected from a rotary stirring method, a centrifugal force dispersion method, a static mixer method, a vibration method, an ultrasonic vibration method, an ultrasonic atomization method, a spraying method, a pulse spraying method, a slot nozzle method, an air assist slot nozzle method, a fine particle spraying slit nozzle method, a centrifugal atomization method of a bell or a disc is used.

According to the present invention, there is provided a method for manufacturing a secondary battery, wherein the secondary battery is a polymer battery and at least electrolyte material is an electrolyte polymer, at least a positive electrode layer on a current collector formed by the above-mentioned method is selected as the object, the electrolyte polymer is applied to the electrode layer, and at least a part of the electrolyte polymer is allowed to penetrate into the electrode.

According to the present invention, there is provided a method for manufacturing a secondary battery, wherein the secondary battery is an all-solid-state battery, at least one of a current collector for positive electrode, a positive electrode layer, a separator, an electrolyte layer, a current collector for negative electrode, and a negative electrode layer is used as the object, a plurality of materials are selected from positive electrode active material particles, electrolyte particles or short fibers, negative electrode active material particles or short fibers, conductive assistant particles or short fibers, binders, and parent solvents for binder, thickeners, and solvents, and are made into a slurry, the slurry is moved from the independent material handling device prepared for the slurry to the application device, the solvent having a boiling point lower than that of the parent solvent for slurry is moved to the application device by another material handling device, and is merged with the slurry to form a merged liquid which is applied to the heated object.

According to the present invention, there is provided a method for manufacturing a secondary battery, wherein for the slurry, a plurality of different types of slurries are prepared for positive electrodes for all-solid-state batteries, the low boiling point solvent is added to each of them, and the slurries are moved from the respective material handling devices to the application device, or the plurality of slurry materials and the low boiling point solvent are mixed and moved to the application device by the material handling device, and the respective slurries are merged and mixed, or the plurality of slurries and the low boiling point solvent are moved to the application device by the material handling device and applied to the object.

According to the present invention, there is provided a method for manufacturing a secondary battery, wherein porous carbon and silicon particles or SiOx particles having a specific surface area of 2000 m²/g or more measured by a BET method are selected as active material for the negative electrode, or at least one is selected from these and single-walled carbon nanotubes, multi-walled carbon nanotubes, and graphene to form a structure that holds the silicon particles or the SiOx particles, and that is contained in a slurry for negative electrode.

According to the present invention, there is provided a method for manufacturing a secondary battery, wherein when applying the one or more types of slurries with a slot nozzle, the slurry is branched into stripes in multiple rows orthogonal to moving direction of the object by combining the slot nozzle wetted portion and one or more shims to make flow of the slurry in application width direction uniform, and the slurry is branched into one step or multiple steps with respect to the moving direction of the object so that the slurry is applied in a plurality of stripes, or a part of downstream of the shim is cut by the entire application width, and stripe flows are merged and applied by the entire width.

According to the present invention, there is provided a method for manufacturing a secondary battery, wherein slurry flow from the slot nozzle is made into spraying particles with a compressed gas outside the slot nozzle or mixed while being crushed, and applied to the object.

According to the present invention, there is provided a method for manufacturing a secondary battery, wherein a plurality of application devices for the merged liquid or the mixed fluid are prepared, and lamination on the object is achieved by the application device for a single slurry or a plurality of slurries.

In the present invention, the type of secondary battery is not limited. A lithium ion secondary battery may be used. A lithium polymer ion battery may also be used.

In addition, the secondary battery of the present invention may be an air battery or an all-solid-state battery. Further, an all-solid-state air battery may also be used.

In addition, in the present invention, the type of sulfide-based or oxide-based solid electrolyte particles is not limited. The type and the shape of active material particles for positive electrode or negative electrode are not limited. The negative electrode active material may be carbon (graphite), particularly porous carbon (graphite) and silicon particles. In order to follow the expansion and contraction of silicon particles during charging and discharging, it is better for carbon to be a followable structure. The structure can be formed by combining at least two or more from porous carbon, carbon nanotubes, graphene or the like. The negative electrode may be a metallic lithium plate or a lithium alloy plate. In addition, as the electrolyte, oxide-based lithium lanthanum zirconia (LLZ) can be used, and further, a NASICON type having a low melting point can be used. In order to improve conductivity, for conductive assistants such as carbon nanofibers and single-walled carbon nanotubes, it is effective to select a solvent that does not cause the agglomeration of conductive assistants to form a slurry or a dispersion liquid, which merges with a slurry flow of active material particles or solid electrolyte particles to enable the application, because the agglomeration can be reduced. The solvent may be liquefied carbon dioxide gas, or liquefied carbon dioxide gas may be made into supercritical fluid (SCF) and carbon nanofibers or the like may be dispersed in the circulation circuit. SCF may be a solvent for the slurry. Since SCF gasifies instantly, especially when the electrode or the like is to be dried, the solvent having a high boiling point also azeotrope due to the evaporation effect, so that the application surface can be dried. Dry application is particularly effective for forming electrodes of secondary batteries.

In the present invention, the method of WO2014/171535 and WO2016/959732 invented by the present inventor can be used or applied.

That is, in the present invention, in order to improve the performance of secondary batteries, especially next-generation secondary batteries such as all-solid-state batteries, it is possible to prevent the silicon particles that expand and contract due to charging and discharging from falling off by forming an additional or composite structure of active material particles for negative electrodes, such as porous carbon particles of macropores, mesopores, etc., and optionally carbon nanotubes, carbon nanofibers, graphene or the like on the object, if necessary, combing with a binder or an adhesive to incorporate the silicon particles and SiOx particles, which are negative electrode active materials, into the structure. Further, when encapsulating or partially adhering electrolyte particles or electrolyte short fibers with a binder, or when applying them or forming a film together with the binder particles or fibers, it is preferable to form spider web-like binder fibers arranged in three dimensions on the substrate in advance with a stable weight per unit area. Selected particles, for example, positive electrode active material particles and electrolyte particles, if necessary, can be alternately laminated and applied in the form of a thin film or filled with the conductive assistants on one substrate, and ejected to, for example, an object under vacuum using differential pressure to enable application or film formation. In particular, when a sulfide-based solid electrolyte is adopted, for the application or filling on the substrate, the filling atmosphere should be arranged in a dry atmosphere, such as a dry chamber with a atmosphere having a dew point above −50° C. or higher, preferably a dew point of −90° C., and an argon atmosphere is better. In particular, the method of WO2016/959732 is convenient for application, and the method of WO2014/171535 which can be applied to an object under high vacuum is convenient for film formation. A plurality of substrates can be prepared corresponding to each material, one substrate is laminated and applied or filled with an active material of positive electrode or negative electrode, and the remaining substrate is laminated and applied or filled with a powder binder such as PTFE and PVDF, which is alternately laminated and applied or formed into a film on the object with the active material. The binder may be attached or encapsulated in a very small amount to the active material or the electrolyte particles in advance. The binder may be a vinyl-based resin or the like dissolved in a solvent, or may be an emulsion. In particular, the binder of negative electrode may be a rubber-based binder such as SBR, glycerin or carboxymethyl cellulose (CMC) or the like may be used as a thickener, and an aqueous solvent may be used. By adding an alcohol-based solvent having a boiling point lower than water in an amount of 3 to 20% by mass relative to water, the aqueous solvent of slurry applied to the heated object evaporates instantaneously by azeotropic boiling. Since the slurry can instantly wet the object, the adhesion of the negative electrode is good. The alcohol-based solvent having a boiling point of water or lower can be selected from ethanol, methanol, acetone, 1-propanol, 2-propanol, etc.

By adding 5% or less of, for example, butyl cellosolve having a boiling point of 150° C. or higher, the leveling at various sites required for the negative electrode can be increased. In addition, in the present invention, by applying glycerin or the like to the object and colliding and laminating the fine particles or the like, heating the object before and after it and moving the object under vacuum, or the like, the glycerin with a boiling point of about 400° C. can also be evaporated with the support of azeotropic boiling, so that a dense laminate (for example, laminate of negative electrode), can be obtained.

In the present invention, it can also be made into a slurry and applied under vacuum. The electrolyte is not limited to sulfide-based and oxide-based electrolytes, and the amount of binder in each slurry is preferably 10% or less of the total solid content in terms of weight ratio, and more preferably 2% or less for reasons such as reducing the residual carbon to a very small amount, especially when being calcinated in a subsequent step. Application using static electricity in an atmosphere under a gas such as argon and nitrogen can also be applied. Further, the application using static electricity can also be performed in a vacuum chamber on the side close to the atmosphere such as dry air, or under non-vacuum. If there is a binder, a potential difference can be provided between the object and the slurry or the fine particles atomized by spraying or the like to electrostatically support the adhesion of fine particles. In particular, the application using static electricity is effective for adhesion of ultra-fine particles of submicron or less. In order to electrostatically charge spraying particles or the like, the binder or the solvent which is easily charged by static electricity should be selected.

According to the method for manufacturing a secondary battery of the present invention, since the spraying particles or the like can be made to collide with an object and adhere to the object with an impact, for example, at a spraying angle of 30 degrees or less, more preferably 15 degrees or less, and at a distance to the object of 70 mm or less, more preferably 50 mm or less, it is possible to form ultra-dense particle groups. Further, since fine unevennesses due to the spraying with an impact and, if necessary, unevennesses of desired sizes due to the trajectory of pulsed spraying pattern can be easily formed at the interface of electrodes, the contact area with the electrolyte layer can be increased, the adhesion can be improved by the anchor effect, and the interfacial resistance can be lowered to the utmost limit. For the effective unevennesses of spraying pattern, the distribution with a large flow rate at both ends of the micro curtain coat can be applied. The object can be heated in the range of 50 to 200° C., not limited to vacuum or non-vacuum. The temperature can be lower or higher.

In addition, in the present invention, as the positive electrode layer, the electrolyte layer, and the negative electrode layer, for all of them, the slurry for electrode or the slurry for electrolyte can be atomized by spraying or the like and laminated to form a laminate. On the other hand, in the positive electrode layer and the negative electrode layer, the active material particles for electrode and the electrolyte particles or the short fibers for electrolyte are independently mixed with a solvent to form a slurry, and if necessary, a binder is added, and in particular, a conductive assistant is added to the positive electrode, with methods such as slot nozzle coat (die coat), roll coat, curtain coat, micro curtain coat, screen coat, the electrode layer can be formed as it is and the processing speed can be increased, but except for slit nozzle and micro curtain coat, it is not a completely closed system, and the low boiling point solvent will evaporate, so it is not a good method. The screen can be used in a wide range of applications because it can be filled with a slurry in a wet state, and after the solvent is volatilized due to the azeotropic boiling of low boiling point solvent, it is extruded in the form of a powder by a gas or the like and sprayed (screen spraying) for application. By using a rotary screen that rotates and moves, a slurry or the like can be transferred or filled to fine screen openings and blown with a compressed gas or the like from the opposite side of the object. A plurality of screen devices can be arranged and stacked in the moving direction of object. The screen pattern shape may be the same, and when different types of slurries such as active material slurry and electrolyte slurry are laminated, the slurry arrangement can be changed to be desired. The screen openings can be manufactured up to a round diameter of about 100 μm or less. Therefore, the active material, the electrolyte particles, and the conductive assistant can be selected and applied so as to have a gradient distribution. The gradient application is more effective in blowing or spraying with particles, especially pulsed spraying, inkjet, dispenser, or a method of adding a compressed gas to the dispenser particles.

On the other hand, in the slot nozzle, the application width (for example, 300 mm) is branched into thin stripes, and for every 10 mm width, preferably every 5 mm or less, more preferably every 1 mm width, a striped groove with a width of, for example, 5 mm to 500 μm or less, more preferably 100 μm or less, if desired, 50 microns or less is formed to make the widthwise pressure distribution of wide slot nozzles uniform, not only the flow rate per stripe can be made uniform, but also the agglomerates of the agglomerated slurry can be applied while being separated. The drawback of the slot nozzle is that the agglomerates are applied as they are. By spraying, the agglomerates can be roughly divided, and by impact pulsed spraying, the agglomerates can almost be divided. A plurality of shims can be prepared to make up for the gaps between the stripes. In addition, different types of slurries, for example, an active material slurry, an electrolyte slurry, a conductive assistant slurry or a solvent dispersion liquid can be applied while being wrapped in a thin stripes.

These methods can be applied to all batteries including fuel cells, regardless of the type of material or solvent.

Further, in the present invention, a single slurry in which a plurality of types of particles are mixed can also be laminated and applied, but the present invention is not limited to this, it is possible to prepare multiple slurries of different types and use the heads of a plurality of tips of the application device corresponding thereto. When mixing particles with different specific gravities and particle sizes, such as particles for electrode and particles for electrolyte, to prepare a slurry with no binder or little binder, no matter how uniform the mixture is, it will settle over time or instantly and the dispersed state will change. An ideal laminate of electrode can be obtained by separately preparing a slurry mainly composed of active material particles for electrode and a solvent and a slurry mainly composed of electrolyte particles or fibers and a solvent, respectively setting the spraying amount to the desired ratio, and laminating each of them in a desired overlapping manner, for example, alternately, in multiple layers in the form of a thin film. In addition, this method is effective for desired distribution and lamination of active materials or electrolyte particles and carbon nanofibers or single-walled carbon nanotubes or the like as conductive assistants, which have significantly different ratios per unit volume and different specific gravities and particle sizes. Since too little or too much conductive assistant per unit volume will affect the performance of the electrode layer, rather than applying as a mixed slurry with active materials and electrolyte particles, it is better to change to a solvent-dispersed state sold by the material manufacturer or a solvent that can be dispersed by customers without problems, and to keep a single state until the stage immediately before application, and the performance can be greatly improved. Further, binders of inorganic and organic particles or fibers, for example, resin-based powders or short fibers such as SBR and PVDF, electrolyte glass-based short fiber binders or the like, and solvents can be added, and if necessary, resin-based solutions and emulsions or the like can be added, the desired materials can be mixed into slurries, and further, they can be made into a plurality of independent slurries for application to a desired place with a desired amount.

In addition, in particular, as the solid content concentration of the conductive assistant slurry decreases, for example, it is made into a dispersed state of a thin film in a slurry state of 10% or less, and is laminated in multiple layers so as to be entwined with the active material particles and the electrolyte particles, the more uniform the application amount per unit area becomes, which leads to the improvement of the battery performance

Further, in the present invention, in order to prevent performance deterioration due to expansion and contraction of silicon and silicon oxide particles, which are effective for the negative electrode, a strong adhesive can be applied so that the silicon particles or the like partially adhere to the carbon of the structure. That is, the silicon particles expand and are supported in the macropores of carbon structure or macropore carbon, and can be further held by a strong adhesive or an adhesive fiber having a large surface area. An electrode layer can also be formed by making the materials into particles with separate heads and laminating them, partially forming adhesive particles or non-woven fibers (spider web-like) on the surface of silicon, which adhere to carbon structure and silicon or SiOx. In particular, a pulsed method with an impact is most suitable for spraying the adhesive or making the adhesive into fine particles, moving them, and partially adhering them to the silicon surface. It is also possible to add carbon particles or the like of negative electrode active material to an adhesive solution or an emulsion of the adhesive to form a slurry, which is then applied.

Further, in the present invention, metallic silicon or silicon oxide of several tens to several hundreds of nanometers is supported in the pores of porous carbon or in the carbon structure, and further supported by an adhesive or the like, so that the dropout due to expansion and contraction of silicon during charging and discharging of the secondary battery can be suppressed.

In addition, the object can be heated. As for the heating temperature, since the drying process can be shortened, it is preferably 30 to 200° C., more preferably 50 to 150° C. By heating the object, the solvent content of the atomized slurry can be brought into contact with the object to get wet and evaporated at the same time. The time to evaporate 95% of the solvent is preferably within 5 seconds, more ideally within 2 seconds. If it is longer than 2 seconds, the particle group deposited at high density due to impact is easily loosened by the solvent. In addition, if all the solvent evaporates instantly at the same time as the collision, the spraying particles or the like are likely to be scattered by the solvent vapor, and bumping or the like is likely to occur in the binder. Generally, as a parent solvent for PVDF or the like, high boiling point NMP with a boiling point of 200° C. or higher is often used in the secondary battery field, but it takes too much time to to evaporate at high temperature, the drying furnace is long, and when the film thickness is increased to, for example, 300 μm, sedimentation is likely to occur when being wet, it is difficult to form electrodes, and cracks are also generated, the difficulty is high. On the other hand, a solvent having a low boiling point of 110° C. or lower is generally a poor solvent for PVDF, but it may be selected from the categories of poor solvents such as acetone, MEK and normal heptane and used as a single solvent or a composite solvent. Although normal heptane, which is not applicable from a PRTR perspective, is a poor solvent, the problem can be solved by using the method of the present invention. If the stirring, collision dispersion, high-speed movement, etc. of the mixed slurry are stopped, these poor solvents will be separated instantaneously, so care should be taken during handling.

In the present invention, when the slurry is atomized and attached to an object, the impact can be increased by being performed in a pulsed manner Especially in the air spraying method called two-fluid spraying in the industry, the mass of air existing around the spraying particles is as large as 400 to 600 times, so the particles that arrive later on the object are pushed back by the air rebounded by the object, and not only the impact is lost, but also the adhesion efficiency of particles is extremely poor. On the other hand, in the impact pulse-like method in which both slurry and air are pulsed, and which is preferably performed with a distance between the nozzle and the object within 50 mm and a spraying angle within 15 degrees, the compressed air diffuses between the spraying particle group and the spraying particle group, and only directional particles move and adhere.

Therefore, the efficiency of adhesion is also as high as 95% or more, which is economical compared to about 30 to 50% of a normal spraying.

By being performed in a pulsed manner, for example, the application amount of conductive assistant or the like can be set to one-tenth or less of a normal spraying, so it is extremely convenient when adjusting the ratio of the conductive assistant to the electrolyte or active material of the electrode.

### Advantageous Effects of Invention

As described above, according to the present invention, a secondary battery having high performance can be manufactured.

### BRIEF DESCRIPTION OF DRAWINGS

FIG. 1 is a schematic cross-sectional view of an embodiment of the present invention, in which a slurry is moved downstream by a material handling device, merged with a low boiling point solvent similarly moved downstream by a material handling device, and sprayed in a pulsed manner by an application device.

FIG. 2 is a schematic cross-sectional view of an embodiment of the present invention, in which a slurry is guided to the nozzle inside the multi-tube at the tip part of the application device, another type of slurry or a low boiling point solvent or the like is guided to the nozzle outside, and their merged liquid is crushed with a compressed gas to form spraying particles at the tip part of the nozzle and sprayed.

FIG. 3 is a schematic cross-sectional view of an application device having a stirring means according to an embodiment of the present invention, in which two types of materials (for example, a single or multiple slurries, a low-boiling point solvent, a conductive assistant dispersion liquid, etc.) are merged downstream of the material switching device located in the extension of each material handling device.

### DESCRIPTION OF EMBODIMENTS

In the following, preferred embodiments of the present invention will be described with reference to the drawings. The following embodiments are given only for the illustrative purpose to facilitate the understanding of the invention, and not intended to exclude feasible additions, replacements, modifications made thereto by persons skilled in the art without departing from the technical scope of the present invention.

The drawings schematically show preferred embodiments of the present invention.

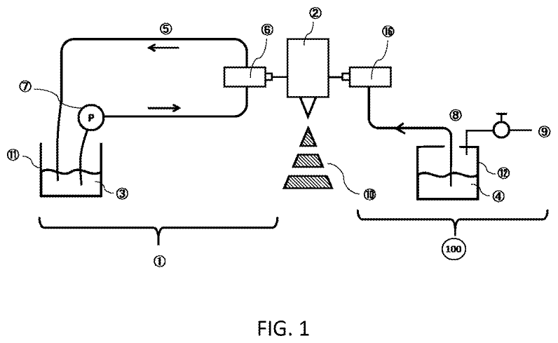

In FIG. 1, the slurry 3 can be handled by the material handling device 1. Specifically, the slurry 3 in the tank 11 is sucked up by the pump 7, and returned to the tank via upstream of the material opening/closing valve 6 by the pipe 5 which is a slurry flow path to form a slurry circulation circuit.

The slurry in the tank is generally stirred by a stirring device or the like (not shown).

When heating the slurry to reduce its viscosity, by installing a heater in the circulation circuit and circulating, temperature management for keeping the temperature of the slurry constant can be performed, so the temperature of the liquid should be constant. At this time, it is important that the slurry is not returned to the tank 11 but is returned to the downstream of the pump 7 to be sucked so that the heating of the slurry 3 in the tank 11 is not promoted by excessive circulating heat. Regardless of whether the slurry is heated with a heater or the like, the faster the circulation speed, the more the particles or the like can be prevented from settling. Circulation amount of the pump is selected from about 0.5 to 30 liters per minute, the circuit passing through the valve is made into a small circulation circuit to adjust the flow rate, and a large-flow-rate circulation circuit (large circulation circuit) that returns from the pump outlet to the tank is formed to generate a jet flow in the tank, or a large flow of slurry is generated in the tank by a stirrer or a circulation flow to prevent precipitation of the slurry. The inner diameter of the pipe or the like of the small circulation circuit may be about 2 to 10 mm, and the larger the inner diameter of the pipe of the large circulation circuit than the inner diameter of the small circulation pipe, the larger the circulation amount can be, so it is good. The pump may be a positive displacement type pump such as a gear pump, a mono pump, a single or double electric plunger pump, or a double electric diaphragm pump, and the drive can be controlled in milliseconds by using a servo motor, so that the accuracy is improved. Other than the positive displacement pump, in particular, it is necessary to keep the pressure of the nozzle or the like attached to the application device and the opening/closing valve constant, so it is necessary to install a hydraulic regulator up to the material opening/closing valve of the material handling device to keep the hydraulic pressure constant. In addition, it is even better to keep the liquid temperature constant. In particular, a hydraulic pressure regulator that follows the millisecond unit is important not only for high-speed line speed of 20 m/min or higher, but also for stability of the application amount.

A low boiling point solvent, a dispersion liquid of the conductive assistant or the like can be handled by the simple material handling device 100. They are filled in the simple pressure pot 12, and the solvent or the like is sent to the material opening/closing valve 16 via the pipe 8 by the gas pressure supply 9, and is sent to the application device by opening the material opening/closing valve 16. The application device 2 can continuously inject the mixture or inject it in a pulsed manner Further, the pattern can be applied to the object of Roll to Roll at a wide range and high speed continuously or in accordance with the cell shape by the slot nozzle. In addition, a commercially available dispersion device manufactured by Primix Corporation or the like, which is capable of micro-dispersion, can be incorporated into the material handling device 1, and the slurry downstream of the dispersion device can be returned to the upstream and circulated while being supplied to the application device. Regardless of whether or not the micro-dispersion device is used, an easily separable slurry at least containing a poor solvent, a parent solvent, and a plurality of particles is circulated in the material handling device 1 so as not to be separated, and the volume of the wetted portion downstream of the material opening/closing valve 16 that is difficult to circulate and the volume of the nozzle flow path is 2 ml or less, preferably 1 ml or less.

For the present invention, even a slot nozzle having a width of 500 mm can have a wetted portion volume of 2 ml or less.

In addition, for the dispersion of a mixture of a slurry containing a plurality of particles or the like (for example, a positive electrode slurry using NMP) and a low boiling solvent such as a poor solvent, it is better to add a micro-dispersion device to the material handling device, or select one or more other dispersing devices such as a dynamic mixer, a static mixer, a dispersion device such as a collision dispersion device, a small-diameter multi-stage filter, etc. and install it in the circulation circuit, and increase the flow velocity by making the inner diameter of the pipe as small as possible, and a spraying nozzle, a slot nozzle or the like having a small volume of the wetted portion can be directly set downstream of the material opening/closing valve, and a good slurry in which the low boiling point solvent is dispersed can be applied to the object. In addition, since the problem of separation can be solved if the volume of the wetted portion inside the nozzle is 2 ml or less, preferably 0.5 ml or less, for example, intermittent pattern coating in accordance with the cell structure is possible.

By incorporating a micro-dispersion device in the material handling device, it is possible to apply a slurry having better dispersion even with a poor solvent.

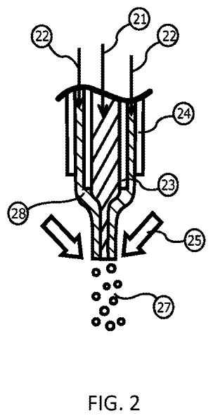

FIG. 2 is a nozzle used at the tip part of the application device (not shown). For the nozzle, a double thin tube made of stainless steel can be applied. As for the material, it may be a plastic tube such as PFA, and the material shape is not limited. The first fluid (slurry) 21 flowing through the inner pipe 23 and the second fluid (solvent) or the low boiling point solvent 28 flowing through the outer tube 24 are crushed by the compressed gas 25 to form spraying particles 27. The first fluid may be in the outer tube and the second fluid may be in the inner tube. In addition, the type and viscosity of each fluid are not limited. The shape and number of the tube are not limited, it may be triple or quintuple, and even if the shape is a multi-row dense tube pipe, a three-dimensional flow path may be formed by combining a shim or the like that is thinly processed into a nozzle flow path with a plurality of flow paths. The shape of the flow path is not limited either, it may be circular or □. Regardless of whether it is a tube or a process, the desired fluid in each flow path is not limited, and for example, it may be a combination of, for example, two or three separate slurries and a low boiling point solvent, or a combination of two or three separate slurries and a conductive assistant dispersion liquid.

The present inventor can alternately apply a plurality of types of slurries in the form of a thin film by using respective application devices, but in the application of the present invention, the liquid containing a plurality of types of slurries can be merged into one application device and applied to the object, so it is possible to use a small booth even with the spraying method, and the software for application can be inexpensive, which is an advantage. For example, when 5 types of slurry materials are included, the 5 types of slurries and the dispersion liquid of the conductive assistant can be independently sent to the application device, but it is possible to divide into groups of three types of liquids and two types of liquids, and merge them with respective application devices for lamination and application. The method of the present invention, in which a plurality of liquids including slurries are merged and applied to the object with one application device, other than secondary batteries, it can also be applied to various applications such as field of batteries (for example, fuel cells, solar cells, especially organic solar cells), semiconductors, FPDs, LEDs, electronics, pharmaceuticals, general coating, etc., and can also be applied to slot nozzle application.

As described above, in the present invention, not limited to the secondary battery, each desired liquid can be transferred to the application device, and applied to the object using spraying, a slit nozzle, or the like.

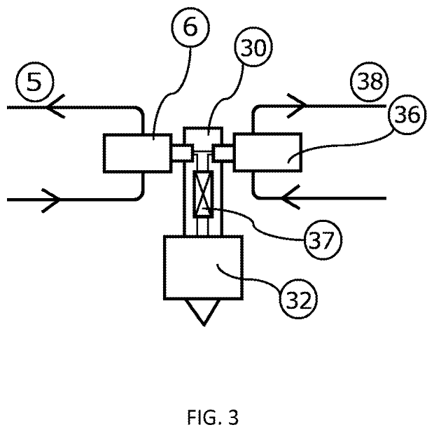

FIG. 3 is a more detailed schematic cross-sectional view of the vicinity of the application device. The first fluid circulates in the pipe 5 via the upstream of the material opening/closing valve 6. The first fluid may be a slurry composed of one or more types of particles. Similarly, the second fluid circulates via the upstream of the material opening/closing valve 36 of the pipe 38. The second fluid may be a slurry. No circulation is required if the second fluid is a non-sedimentable, low viscosity liquid. The first fluid moves from the downstream of the material opening/closing valve 6 to the application device provided with the stirring device 30. Similarly, the second fluid also moves from the downstream of the material opening/closing valve 36 to the application device 32 provided with the mixing device 30 or the stirring means 37, and merges with the first fluid. The two fluids can be mixed and dispersed well by high-speed movement mixing, ultrasonic vibration mixing, collision mixing as shown in the figure, or a combination thereof of the stirring mechanism 37 such as a dynamic mixer, a static mixer. By making the flow path of the head-on collision mixing device (30) of the two materials shown in the figure in the form of a nozzle, collision stirring can be performed close to the outlet of the flow path. A short distance of 1 mm or less is preferable between the flow paths of the left and right nozzles, etc., and it is important to make a head-on collision, and it is also important to increase the flow velocity and increase the head-on collision energy by making the diameter of the nozzle flow path 500 μm or less, more preferably 300 μm or less. In addition, a sufficient collision flow velocity can be obtained by increasing the volume of the merging part as much as possible, for example, by setting the inner diameter to be four times or more the nozzle diameter. The higher the hydraulic pressure, for example, 0.3 MPa or more, or even 10 times or more, the more ideal.

In the present invention, a method similar to the method of JP2003-300000, of which the present inventor is the representative inventor, can be adopted as a material handling device for experiments and semi-production. It is especially effective when the amount of slurry or the like is small, that is, a uniform mixed state of slurry can be created by installing level sensing by an optical fiber sensor near the lower part of the syringe where the inner diameter of the syringe changes to control the level of the slurry, setting the pressure to push the slurry to 30 kPa or more, preferably 65 kPa or more, and moving the slurry in the left and right syringes left and right at high speed, and switching for example, a 70 cc slurry in 2 seconds with syringes of about 70 cc on the left and right, and switching the syringe pressure left and right while creating a jet at the lower part of the syringe. Therefore, a slurry composed of active material particles of a secondary battery, a conductive assistant, a binder such as PVDF, and NMP as a parent solvent is created in a state where the mixed state is relatively stable by moving the slurry with a normal syringe, when about 10% of normal heptane having a boiling point of 100° C. or lower is added to the slurry, it is instantly separated, and normal heptane floats on the upper part of the left and right syringes. This poor solvent cannot be used when it is separated from the slurry, but it can be solved by being performed under the above-mentioned conditions. That is, a poor solvent is dispersed and mixed well in the slurry by a jet flow at the lower part of the syringe, the high boiling point NMP evaporates due to the azeotropic effect of volatilization of low boiling point normal heptane, which is a poor solvent, and the sprayed slurry can form an ideal electrode on the heated object. That is, by using syringes of about 50 to 70 cc or two containers that are relatively larger, the poor solvent and the slurry are moved in the syringe while causing a jet flow at the lower part of the syringe and dispersing together, it can be used as a small-quantity production in a test device or semi-production system even without using two expensive material handling devices. An upper limit sensor of fiber is provided on the upper parts of the left and right syringes to be used as a level control and an upper limit sensor.

In the present invention, in order to improve productivity, for example, a slit nozzle having a width of 200 to 1500 mm can be used for application to the object corresponding to the high-speed line speed. In addition, for each layer of one type of slurry applied, 1 to 200 spraying heads can be arranged in substantially one row or a plurality of rows orthogonal to the moving direction of the object to form a head group to enable the spraying or spraying with impact in a pulsed manner. If necessary, the head group can be reciprocated (swing) by, for example, 15 mm in the head arrangement direction to sufficiently wrap a pattern of, for example, 15 mm Heads for a required type of slurry and heads for a desired number of times of lamination can be arranged to meet the required speed.

In addition, a plurality of rotary screens or the like may be installed in the moving direction by applying JPH6-86956 also invented by the present inventor. By filling the slurry and powder to in numerous holes that penetrate through a wide range (for example, holes with a diameter of about 150 to 300 μm) in cylindrical screens or seamless belts or pipes made of stainless steel or the like that are the same as or wider than the application width of the object, and blowing out with liquefied gas or compressed gas at the place facing the object, it is made into fine particles and adheres to the object uniformly over the entire surface. It is cheap to use a commercially available sheet screen for screen printing or a screen for rotary screen. In addition, the same effect can be obtained by making holes having a diameter of, for example, about 0.2 mm to 0.5 mm at a pitch of 0.5 to 2.0 mm, for example, in zigzags, in a cylindrical pipe wider than the object.

In the above two methods, it is better to set the distance between the position where the atomization and blow-out is performed and the object to be about 1 to 60 mm because the impact effect is improved. It is even better to arrange them in multiple rows in the moving direction of the object for lamination in the form of a thin film Through-holes of screen and cylinder can be formed, for example, in a pattern corresponding to a cell. As a matter needless to say, it can be continuously applied to the object without interrupting the application. In addition, the above method also serves as a positive displacement supply method and can also follow the line by changing the rotation speed, so that an expensive positive displacement pump or controller or the like is not required, and the device design and manufacture can be carried out on the extension line of Roll to Roll of the roll coater and the rotary screen printing method, and it is a positive displacement type different from the above-mentioned method, so it is also possible to modify and use a part of the electrode line of the conventional lithium battery.

In the present invention, a method of making the slurry into particles and moving them by pressure difference may be used, inkjet and dispenser may be used for atomization. Further, as for inkjet and dispenser, it can be applied in the form of a thin film by further micronizing the particles with a compressed gas or the like. In addition, it may be atomized by a rotary atomizer of a disc or a bell used in the general coating field. Other than that, any method such as atomization with a bubbler or ultrasonic wave, or a method of hitting a spraying flow against a rotating roll at an extremely close distance for further micronization may be used. The atomized particle group may be moved by a carrier gas and adhered to the object by differential pressure.

The differential pressure can increase the impact by pulling out the particles by the ejector effect at a higher gas pressure just before the adhesion and colliding them at high speed.

This method can be widely applied not only in the field of secondary batteries but also in coatings in the fields of solar cells, semiconductors, electronics, biotechnology, pharmaceuticals or the like. The carrier gas can be pulsed and the uniform coating is also possible on uneven surfaces. By charging the fine particles, the uniformity and coating efficiency can be further improved and a good effect can be exhibited. The differential pressure can increase the impact by pulling out the particles by the ejector effect at a higher gas pressure just before the adhesion and colliding them at high speed.

Further, it is even better if the movement is performed in a pulsed manner because the adhesion efficiency and impact are increased.

### INDUSTRIAL APPLICABILITY

According to the present invention, even if NMP is used, a positive electrode having a thick film thickness without defects such as cracks can be formed, so that a secondary battery having high performance can be manufactured. In addition, a laminate composed of an electrolyte layer and electrode layers of an all-solid-state battery having low interfacial resistance and high adhesion can also be manufactured with a thick film thickness and high quality from a desired thin film.

### DESCRIPTION OF THE REFERENCE NUMERAL

1, 100 material handling device
2, 32 application device
3 slurry
4 solvent
5, 8, 38 pipe
6, 16, 36 material opening/closing valve
7 pump
9 gas pressure supply
10 pulse spraying
11 tank
12 pressure pot
21 first fluid (slurry)
22 second fluid (solvent)
23 inner nozzle
24 outer nozzle
25 compressed gas
27 spraying particles
28 low boiling point solvent
30 mixing device
37 stirring means

1. A method for manufacturing a secondary battery, which includes an assembly of a positive electrode, a negative electrode, and an electrolyte material of the secondary battery, comprising:
preparing a slurry from a plurality of materials selected from positive electrode active material particles, electrolyte materials, negative electrode active material particles or short fibers, conductive assistant particles or short fibers, thickeners, binders, and parent solvents for the thickeners or the binders;
moving the slurry from an independent material handling device prepared for the slurry;
moving a solvent having a boiling point lower than that of a parent solvent for the slurry by another material handling device;
merging the slurry and the low boiling point solvent to form a merged liquid; and
applying the merged liquid to the object; and
wherein the object is at least one of a current collector for positive electrode, a positive electrode layer, a separator, an electrolyte layer, a current collector for negative electrode, and a negative electrode layer.

2. The method according to claim 1, wherein the low boiling point solvent is mixed with the slurry in advance to form a mixed fluid, the mixed fluid is dispersed in the material handling device to form a dispersed slurry, and the dispersed slurry is circulated at a flow velocity that does not cause separation of the low boiling point solvent and the slurry, or is moved to an application device and applied to the object by the application device.

3. The method according to claim 1, wherein the object is heated at the time of application, evaporation of the parent solvent is accelerated by the evaporation of the low boiling point solvent, and the slurry is applied by the application device.

4. The method according to claim 1, wherein the low boiling point solvent is a poor solvent with respect to the binder.

5. The method according to claim 1, wherein the binder or the thickener for slurry can be selected from a plurality of types, a parent solvent can be selected as the solvent for binder, and particles of the slurry can be selected from a plurality of types of solid particles or short fibers, or a single or multiple independent slurries selected from a plurality of types of particles or short fibers are prepared, they are mixed with the low boiling point solvent to form a mixed fluid which is applied to the object, as method for mixing or applying them, at least one method selected from a rotary stirring method, a centrifugal force dispersion method, a static mixer method, a vibration method, an ultrasonic vibration method, an ultrasonic atomization method, a spraying method, a pulse spraying method, a slot nozzle method, an air assist slot nozzle method, a fine particle spraying slit nozzle method, and a centrifugal atomization method of a bell or a disc is used.

6. A method for manufacturing a secondary battery, wherein the secondary battery is a polymer battery and at least electrolyte material is an electrolyte polymer, at least a positive electrode layer on a current collector formed by the method according to claim 1 is selected as the object, the electrolyte polymer is applied to an electrode layer, and at least a part of the electrolyte polymer is allowed to penetrate into the electrode.

7. The method according to claim 2, wherein the secondary battery is an all-solid-state battery, at least one of a current collector for positive electrode, a positive electrode layer, a separator, an electrolyte layer, a current collector for negative electrode, and a negative electrode layer is used as the object, a plurality of materials are selected from positive electrode active material particles, electrolyte particles or short fibers, negative electrode active material particles or short fibers, conductive assistant particles or short fibers, binders, and parent solvents for binder, thickeners, and solvents, and are made into a slurry, the slurry is moved from the independent material handling device prepared for the slurry to the application device, the solvent having a boiling point lower than that of the parent solvent for slurry is moved to the application device by another material handling device, and is merged with the slurry to form a merged liquid which is applied to the heated object.

8. The method according to claim 2, wherein for the slurry, a plurality of different types of slurries are prepared for positive electrodes for all-solid-state batteries, the low boiling point solvent is added to each of them, and the slurries are moved from the respective material handling devices to the application device, and the respective slurries are merged and mixed in the application device, or the plurality of slurry materials and the low boiling point solvent are mixed and moved to the application device by the material handling device, and are applied to the object.

9. The method according to claim 1, wherein porous carbon and silicon particles or SiOx particles having a specific surface area of 2000 m²/g or more measured by a BET method are selected as active material for the negative electrode, or at least one is selected from these and single-walled carbon nanotubes, multi-walled carbon nanotubes, and graphene to form a structure that holds the silicon particles or the SiOx particles, and that is contained in a slurry for negative electrode.

10. The method according to claim 2, wherein when applying the one or more types of slurries with a slot nozzle, the slurry is branched into stripes in multiple rows orthogonal to moving direction of the object by combining the slot nozzle wetted portion and one or more shims to make flow of the slurry in application width direction uniform, and the slurry is branched into one step or multiple steps with respect to the moving direction of the object so that the slurry is applied in a plurality of stripes, or a part of downstream of the shim is cut by the entire application width, and stripe flows are merged and applied by the entire width.

11. The method according to claim 5, wherein slurry flow from the slot nozzle is made into spraying particles with a compressed gas outside the slot nozzle or mixed while being crushed, and applied to the object.

12. The method according to claim 2, wherein a plurality of application devices for the merged liquid or the mixed fluid are prepared, and lamination on the object is achieved by the application device for a single slurry or a plurality of slurries.
